(19) United States
(12) Patent Application Publication
(10) Pub. No.: US 2014/0344067 A1
(43) Pub. Date: Nov. 20, 2014

(54) PURCHASE SHARING SYSTEMS

(71) Applicant: Joseph M. Connor, IV, Grosse Pointe Woods, MI (US)

(72) Inventor: Joseph M. Connor, IV, Grosse Pointe Woods, MI (US)

(21) Appl. No.: 14/278,730

(22) Filed: May 15, 2014

Related U.S. Application Data
(60) Provisional application No. 61/823,718, filed on May 15, 2013.
(60) Provisional application No. 61/885,167, filed on Oct. 1, 2013.

(51) Int. Cl. G06Q 50/00; G06Q 30/02

(52) U.S. Cl. CPC G06Q 50/01; G06Q 30/0269
USPC 705/14.66

(57) ABSTRACT

A purchase sharing system, comprising: a processor; a camera controlled by the processor; a user interface controlled by the processor; a wireless communications module controlled by the processor; and tangible non-transitory computer-readable media having instructions, that when executed by the processor, cause the processor to perform the steps of: receive, from the camera, an input of media; receive, from the user interface, customer information; generating a message to the customer, wherein the message includes media, and a prepopulated status message, wherein the prepopulated status message include a reference to a product, a reference to a salesperson, and a reference to a business at which the product was purchased, and a link to a URL that when visited posts the prepopulated status message on the social network; transmitting, via the wireless communications module, the message to the customer.

### CROSS-REFERENCE TO RELATED APPLICATIONS

This application incorporates by reference and claims benefit to U.S. Provisional Patent Application No. 61/823,718, filed May 15, 2013, and U.S. Provisional Patent Application No. 61/885,167, filed Oct. 1, 2013.

### BACKGROUND OF THE INVENTION

The present subject matter relates generally to systems for salespeople to promote sharing of consumer purchases on social networks. More specifically, the present invention relates to a system for salespeople to invite consumers to share and review purchases on social networks and review sites via prepopulated status updates.

Social sharing of a purchase by customers is an effective tool for businesses and salespeople to build goodwill towards their goods and services. As is well known, a person is more likely to become a customer after seeing a product or service endorsed by friends. Likewise, a customer's social recommendations or testimonial of a particular salesperson who assisted in the purchase of a good and service may make friends of the customer more pre-disposed to both the goods or service and the salesperson. Potential customers are inclined to be wary of salespeople, but will often seek out salespeople who are recommended by friends. Thus, what are needed are systems for businesses and salespeople to encourage social sharing of purchases by customers and to include information about the purchase, the business, and the salesperson involved.

Accordingly, there is a need for a purchase sharing system for showcasing salespeople, as described herein.

### SUMMARY OF THE INVENTION

To meet the needs described above and others, the present disclosure provides a purchase sharing systems for salespeople to use to easily encourage customers to share purchases on social networks and review websites by offering to send the customer a picture or video of the customer with the new purchase and including with the image or video pre-populated social sharing prompts to encourage the sharing of the purchase with the customers social network. By leveraging the customer's initial enthusiasm after a purchase, purchase sharing systems may enable a salesperson to lower the customer's resistance to sharing social network information and increasing the customer's comfort sharing a purchase on his or her social networks.

The purchase sharing system may be provided as a purchase sharing application executed on a mobile device of the salesperson. Encouraging purchase sharing begins with the salesperson offering to send the customer a picture or video of the customer with the purchase. If the customer agrees, the salesperson may launch the purchase sharing application and capture a picture or video of the customer with the purchase using the camera of the mobile device.

After that, the salesperson may then be directed to a screen of the purchase sharing application to enter appropriate contact information of the customer, or retrieve the information from the contact list of the mobile device. The contact information may include a phone number, email address, social network aliases, review site aliases, etc. The contact information may include contact information for multiple social networks of the customer, such as Facebook, Twitter, Google+, Pinterest, Instagram, etc., and for multiple review websites, such as Yelp, DealerRater.com, etc. The salesperson may also enter his or her social network information and the social network information of the business, or the salesperson's and businesses' information may be pre-populated from previous entry. The salesperson may then choose the medium by which to send the message to the customer, such as by e-mail or text message. Next, the purchase sharing application may send a message or messages to the customer using the contact information provided using the medium chosen.

In an embodiment, the message may be an email message. As shown below, an email message may include congratulatory text and the picture or video of the customer with the purchase and may further include one or more invitations to share the purchase on a social network. As will be further described below, the email message may be an abbreviated version of a longer message, and/or may include a link to a longer message or further information on a website associated with the application.

In an embodiment, the message may be a text message. The text message may be an abbreviated version of a longer message, and/or may include a link to a longer message or further information on a website associated with the application.

As mentioned above, an email or text message may include a link to a longer message or further information. The longer message may include one or more invitations to share the purchase on a social network. The website may present multiple invitations or permit the purchaser to choose social networks on which to share the status message. For each available social network, the website may includes a share prompt that, when activated, posts a social network status. The social network status may be prepopulated with the image or video, the name of the product or service, the business where the purchase was made, and/or the name of salesperson.

An invitation to share the purchase on a social network in a message may be linked to a social network status prepopulated with the image or video, the name of the product or service, the business where the purchase was made, and/or the name of salesperson. The invitation may show a preview of the social network status and may include a share prompt that when activated posts a social network status. An invitation may permit a user to select social networks on which to post the status update.

The social network status may be prepopulated with the image or video, the name of the product or service, the business where the purchase was made, and/or the name of the salesperson that assisted in the purchase. The social network status may further include tags related to the image or video, the product or service, the business where the purchase was made, and the salesperson.

The email message or text message may further include review prompts to encourage the customer to write reviews for the purchase, the business where the purchase was made, and/or the salesperson on review websites. The review prompts may be pre-populated with information about the purchase, the product, the business, or the salesperson. The review prompts may further include incentives to encourage the customer to write a review. For example, promising a gift card for writing a review may incentivize a customer to write a review of the purchase.

The share prompt and review prompts may both be hyperlinks configured to provide the functionality described. In an embodiment, a share prompt or a review prompt may be a hyperlink to the desired social media or review website including status update information or review information in the query to be pre-populated. In an alternate embodiment, a share prompt or a review prompt may be a hyperlink to a web site associated with the purchase sharing application that uses the social media website application programming interface (“API”) or review website API to create and post and the status update or pre-populated review.

After a customer activates the share prompt or review prompt, the status update appears in the social network feed of the customer, the salesperson, and the business. In some embodiments, if the purchase has a social media product page, the purchase is also tagged. As shown in the figure below, the customer, the purchase, the salesperson, and the business are all tagged with bolded hyperlinks in the social network status update. The social network status update may appear to any user of the social network who receives social network updates of any of the tagged entities, and the user may click on any of the tags to view further information. For example, a user may click on the salesperson's tag to view the salesperson's profile and to contact the salesperson about making a purchase.

The purchase sharing application may contain further features for interacting with the customer after the purchase. For example, the application may monitor the customer's social media activity and send notifications to the salesperson. For instance, if the purchaser writes an online review, a salesperson user may be notified of the review and may respond to the review. Additionally, the purchase sharing application may be configured to communicate with service scheduling application provided by the business. A service scheduling application may be provided by the business to assist the purchaser with maintenance of the item. For example, if the purchase is a vehicle, the service scheduling application may notify the user of a need to rotate the tires. As an example, the application may communicate with the service scheduling application to permit a salesperson at a dealership user to automatically respond to a download of the service scheduling application, perhaps to congratulate the purchaser on the purchase and to offer future deals on service at the dealership.

In an embodiment, a purchase sharing system, includes: a processor; a camera controlled by the processor; a user interface controlled by the processor; a wireless communications module controlled by the processor; and tangible non-transitory computer-readable media having instructions, that when executed by the processor, cause the processor to perform the steps of: receive, from the camera, an input of media; receive, from the user interface, customer information; generating a message to the customer, wherein the message includes media, and a prepopulated status message, wherein the prepopulated status message include a reference to a product, a reference to a salesperson, and a reference to a business at which the product was purchased, and a link to a URL that when visited posts the prepopulated status message on the social network; transmitting, via the wireless communications module, the message to the customer.

In some embodiments, the message is one of an email or an SMS message. Also, in some embodiments, the media is one of an image or a video. Additionally, in some embodiments, the reference to the product is a link to a social network profile of the product, wherein the reference to the salesperson is a link to a social network profile of the salesperson, and wherein the reference to the business is a link to a social network profile of the business.

In some embodiments, the reference to the product is a link to a website of the product, wherein the reference to the salesperson is a link to a website of the salesperson, and wherein the reference to the business is a link to a website of the business. Additionally, in some embodiments, the message is an SMS message, wherein the message includes an abbreviated portion sent via SMS and a full version accessible using a uniform resource locator, and wherein the abbreviated portion includes the uniform resource locator.

In an embodiment, a purchase sharing system includes: a processor; a communications module controlled by the processor; and tangible non-transitory computer-readable media having instructions, that when executed by the processor, cause the processor to perform the steps of: receive, via the communications module, one or more social network aliases and review website aliases of a customer, and a product reference to a purchase associated with the social network aliases and review website aliases of the customer; monitoring, via the communications module, the activity of the customer on a social network for activity related to the purchase associated with the social network alias or review website alias of a customer; and when activity is detected, transmitting, via the communications module, a notification of the activity.

In some embodiments, the activity is a review of one of the purchase, a salesperson, and a business. Additionally, in some embodiments, the tangible non-transitory computer-readable media has further instructions, that when executed by the processor, cause the processor to perform the steps of: detecting the passage of a pre-determined period of time associated with the purchase; and transmitting to the customer a reminder to perform an action associated with the purchase. In some embodiments, the reminder is a reminder to service the vehicle.

In some embodiments, the product reference is the make, model, and date of purchase of a vehicle. Additionally, in some embodiments, the tangible non-transitory computer-readable media has further instructions, that when executed by the processor, cause the processor to perform the steps of: receiving an indication of the downloading of an application to a mobile device, wherein the indication includes one of the one or more social network aliases and review website aliases of a customer; and wherein the step of transmitting to the customer a reminder to perform an action associated with the purchase is accomplished by transmitting the reminder to the mobile device.

An object of the invention is to provide a solution to the difficulties of getting customers to share the contact information of the salesperson and information about the business where the purchase was made on social networks.

Another object of the invention is to provide mechanisms to encourage purchasers to leave reviews.

An advantage of the invention is that it provides a mechanism for purchasers to easily share purchases.

Another advantage of the invention is that it provides a mechanism for purchasers to easily review purchases.

A further advantage of the invention is that it provides valuable advertising for salespeople and businesses.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates the ecosystem of an example purchase sharing system embodied in a mobile device.

FIG. 2 is a block diagram representation of an example implementation of a device.

FIG. 3a is a flowchart of an example purchase sharing method according to the teachings provided herein.

FIG. 3b is a flowchart of an example customer relationship management method according to the teachings provided herein.

FIG. 4 is an input screen of the mobile device for receiving an input of media.

FIG. 5a is a customer contact screen of the mobile device to enter customer information.

FIG. 5b is a business contact screen of the mobile device to receive business information.

FIG. 6 is an example of a purchase-sharing message generated by the mobile device provided as an email message.

FIG. 7 in another example of a purchase-sharing message generated by the mobile device provided as an SMS message.

FIG. 8 is an example of a purchase-sharing message generated by the mobile device provided as a webpage.

### DETAILED DESCRIPTION OF THE INVENTION

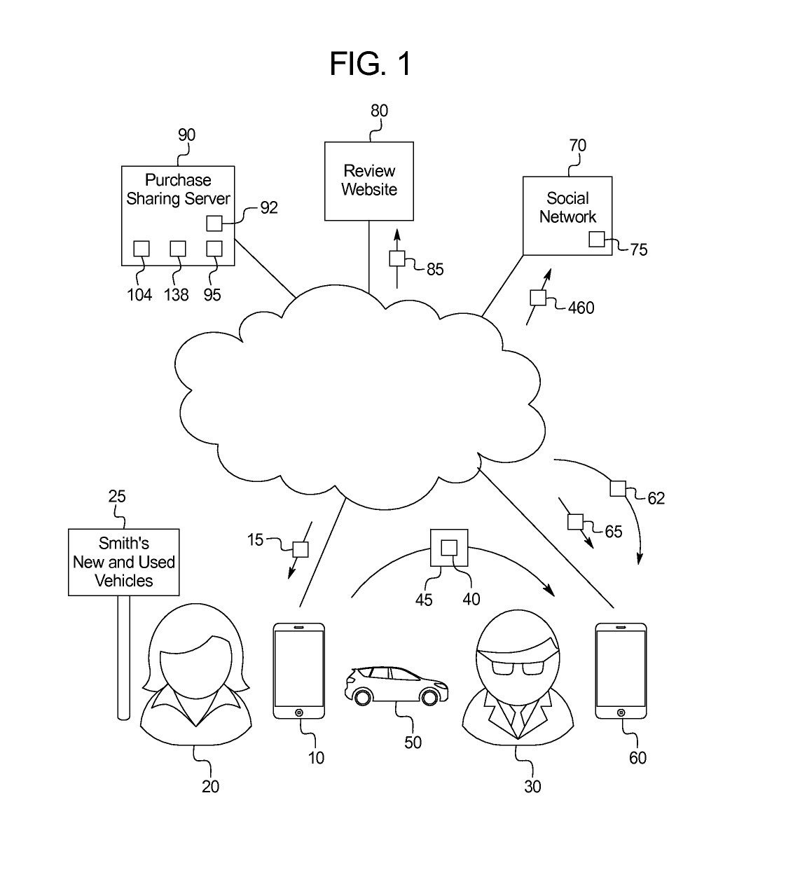

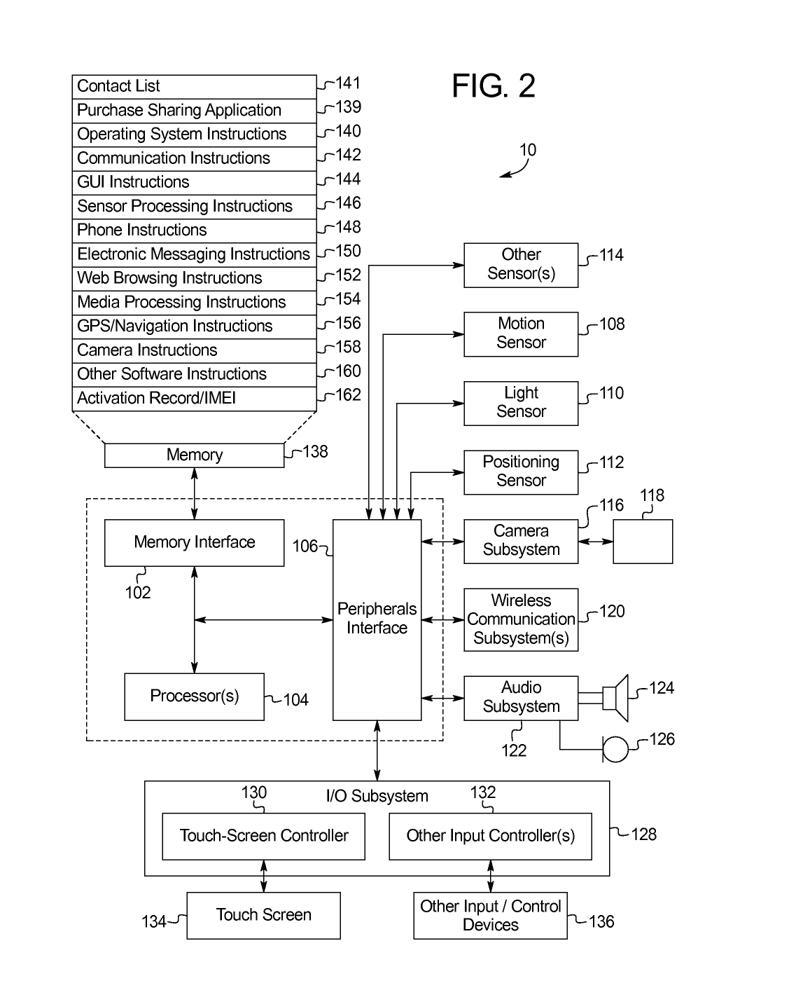

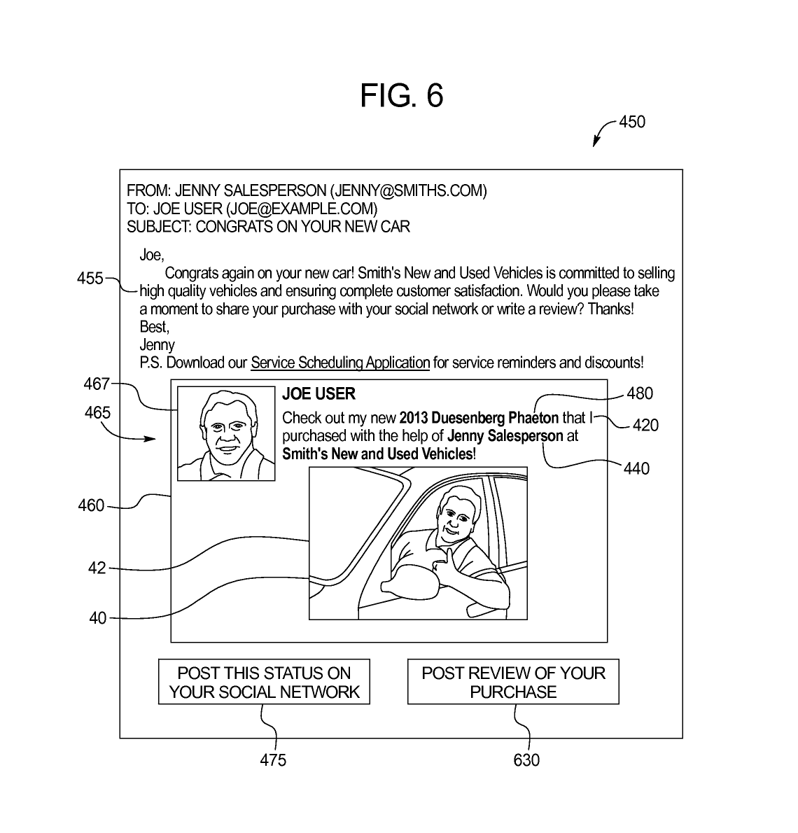

FIG. 1 illustrates the ecosystem of an example of a purchase sharing system embodied in a mobile device 10 running a purchase sharing application 139 (FIG. 2). FIG. 2 is a block diagram representation of an example implementation of a mobile device 10. As shown in FIG. 1, purchase sharing begins when a salesperson 20 working at a business 25 offers to send the customer 30 a picture 42 or video 44 of the customer 30 with the purchase 50. If the customer 30 agrees, the salesperson 20 may launch the purchase sharing application 139 on the mobile device 10 and capture media 40, such as a picture 42 or video 44 of the customer 30 with the purchase 50 using the camera 118 of the mobile device 10. The salesperson 20 may then transmit the media 40 to the customer 30 in a message 45 (FIGS. 6-8) with a share prompt 475 to share prepopulated status message 460 highlighting the purchase 50 on a social network 70 or an invitation to post a review 85 of the purchase 50 on a review website 80.

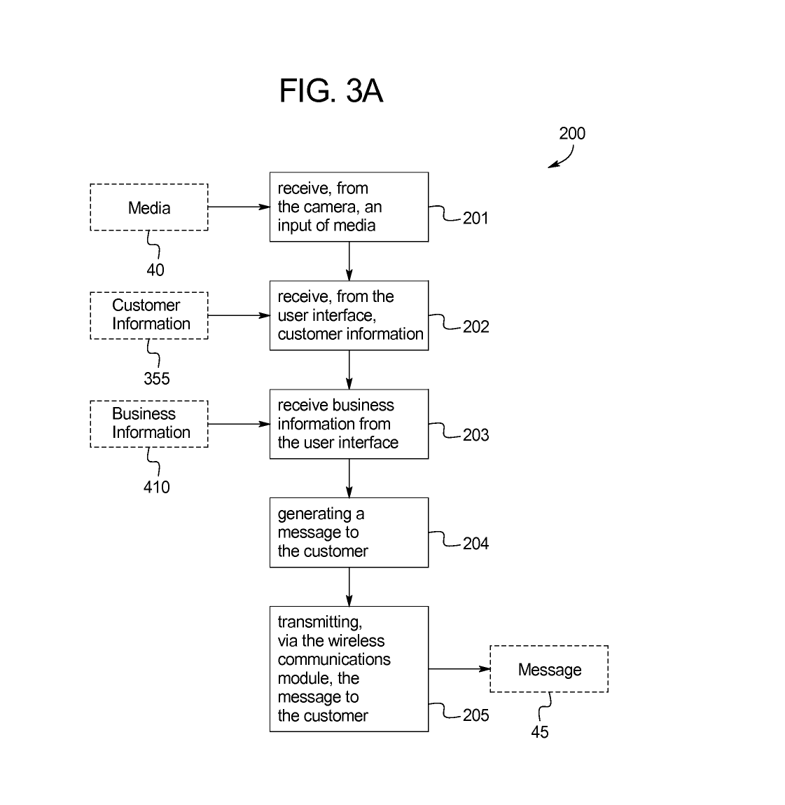

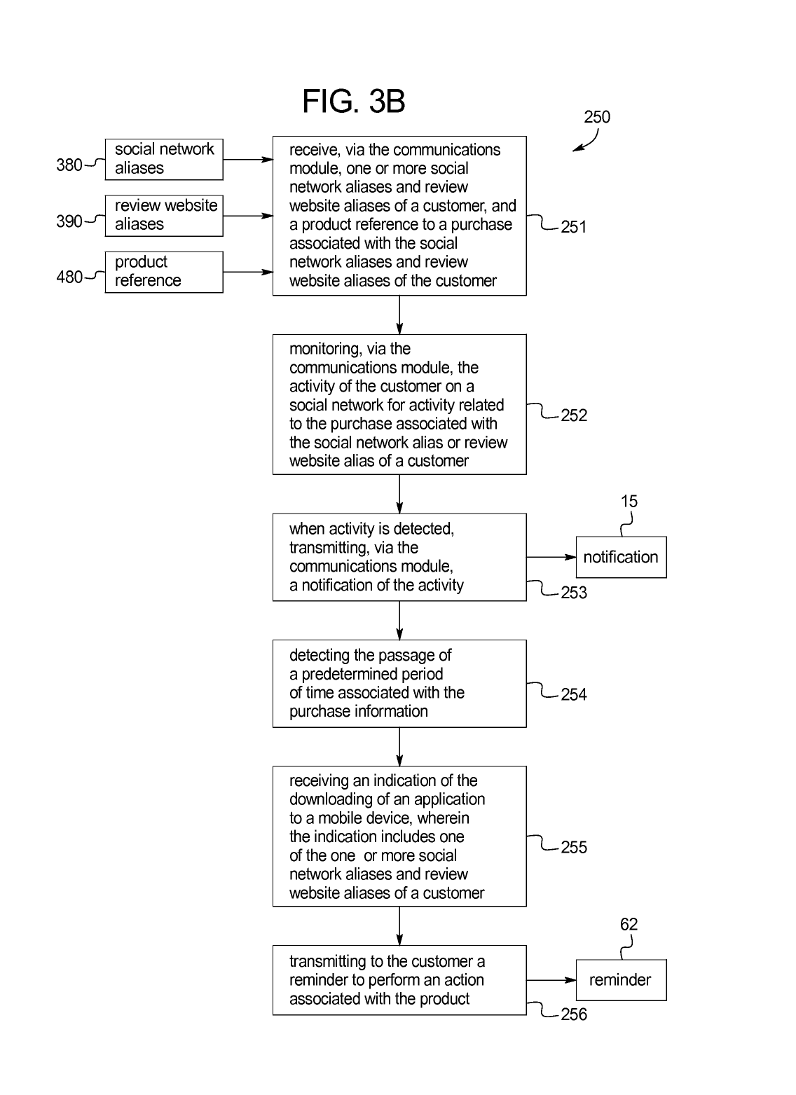

In one example, the salesperson 20 may launch a purchase sharing application 139 on the mobile device 10 to cause the mobile device 10 to execute a purchase sharing method 200. As shown in FIG. 3a, the purchase sharing method 200, when executed by a processor of the mobile device 10, cause the processor to: receive an input of media 40 from the camera 118 at step 201; receive customer information 355 from the user interface at step 202; receive business information 410 from the user interface at step 203; generating a message to the customer at step 204; and transmitting the message to the customer via the wireless communications module at step 205.

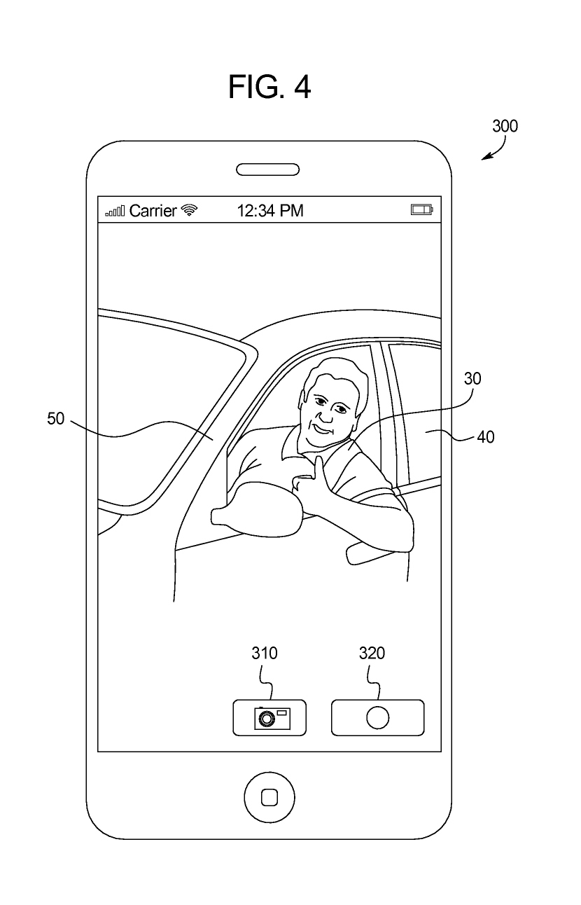

As shown in FIG. 4, purchase sharing begins at step 201 when the salesperson 20 launches the purchase sharing application 139 and is directed to an input screen 300. Using the input screen 300, the salesperson may then capture media 40 of the customer 30 with the purchase 50. Thus, a shutter button 310 may be used to take a picture 42 of the customer 30 with the purchase 50. Likewise, a record button 320 may be used to capture a video 44 of the customer 30 with the purchase 50.

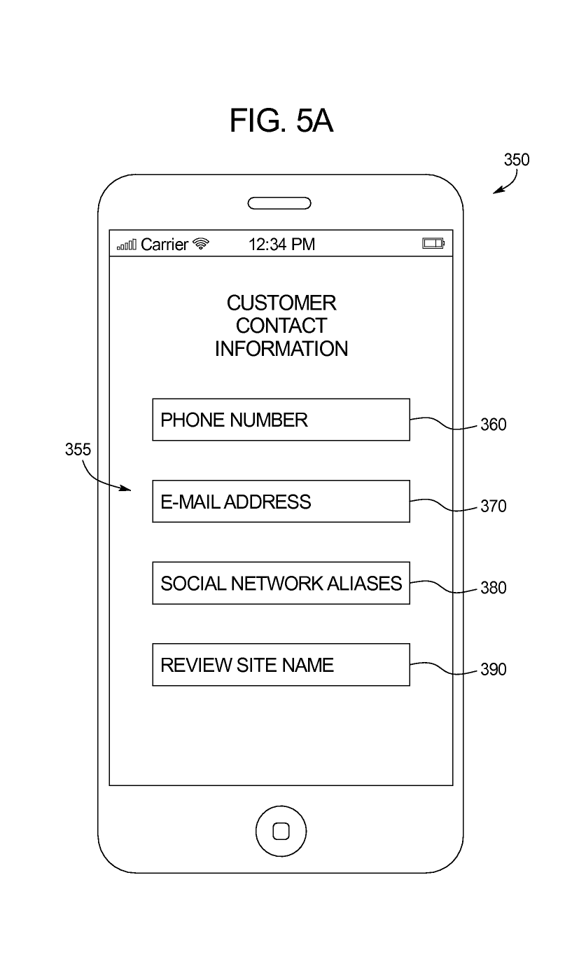

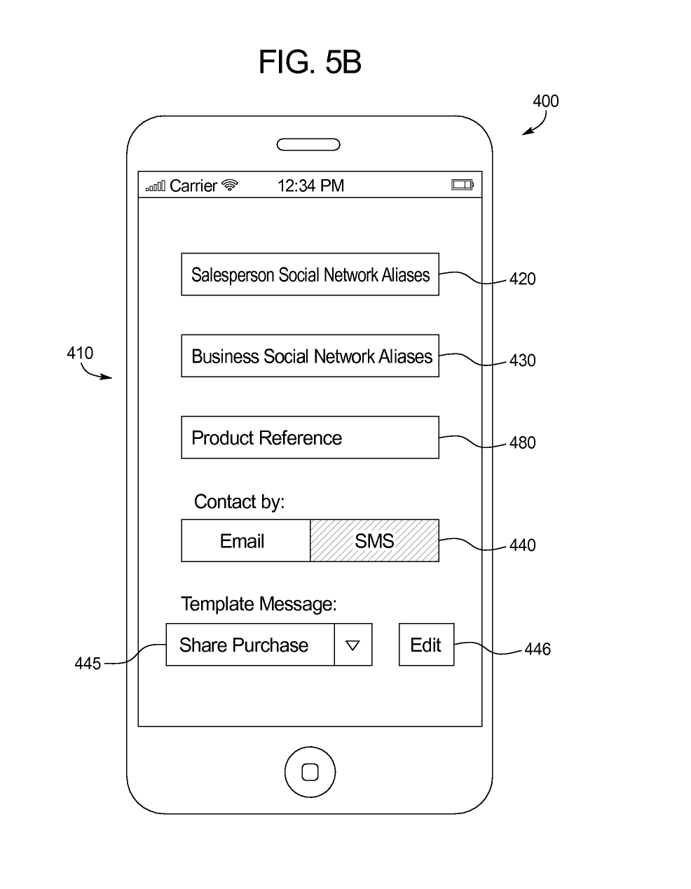

As shown in FIG. 5a, at step 202, the salesperson 20 may then be directed to a customer contact screen 350 on the device 10 to enter appropriate customer information 355 of the customer 30, such as contact information, or retrieve the customer information 355 from a contact list 141 of the mobile device 10. The customer information 355 may include a phone number 360, email address 370, social network aliases 380, review website aliases 390, etc. The customer information 355 may include customer information 355 for multiple social networks 70 of the customer 30, such as Facebook, Twitter, Google+, etc., and for multiple review websites, such as Yelp, DealerRater.com, etc.

As shown in FIG. 5b at step 203, at a business contact screen 400, the salesperson 20 may also enter business information 410, such as his or her salesperson social network alias 420 and the business social network alias 430. The business information 410 may be pre-populated from previous entry. Additionally, the salesperson 20 may specify a product reference 480 referencing the purchase 50. A product reference 480 may be a textual description of the product, a link to a webpage regarding the product, a tag or hashtag of the product (that may be used to view the discussion of the product across social media), etc. The salesperson 20 may then choose the medium 440 by which to send the message 45 to the customer 30, such as by e-mail or text message. The salesperson 20 may then choose a template message 445, and may modify the template message 445 by clicking an edit button 446.

Next, at step 204, the mobile device 10 generates the message 45 to the customer from the template message 445. The template message 445 may have computer-editable fields that may be populated automatically by the processor 104. In an embodiment, the message 45 may be provided as a postcard, as may be accomplished by integrating with services such as Postagram or Touchnote. In a preferred embodiment, the message 45 may be provided as an email message 450 as shown in FIG. 6.

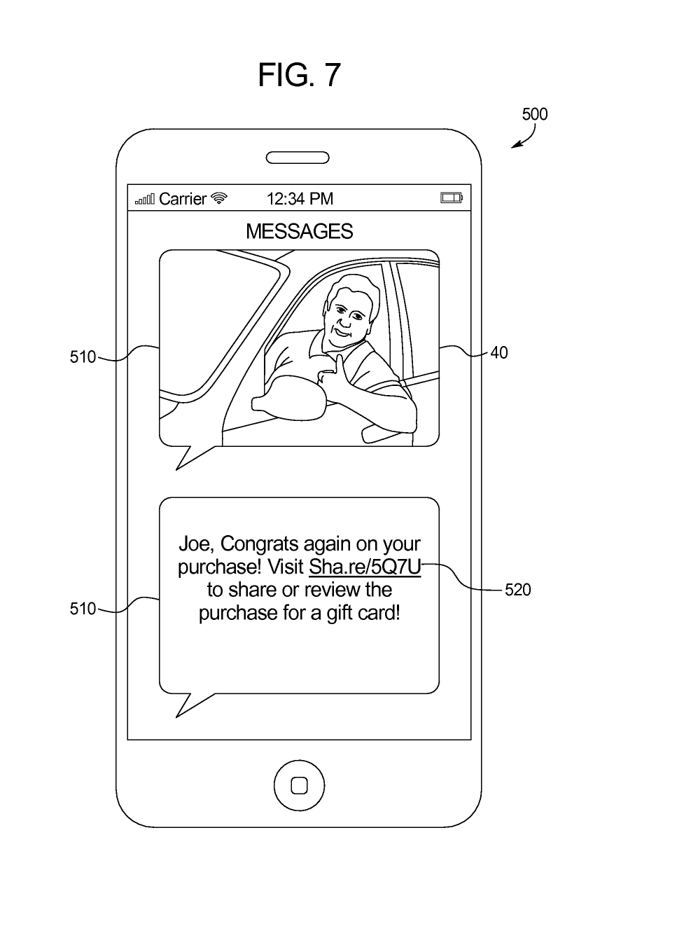

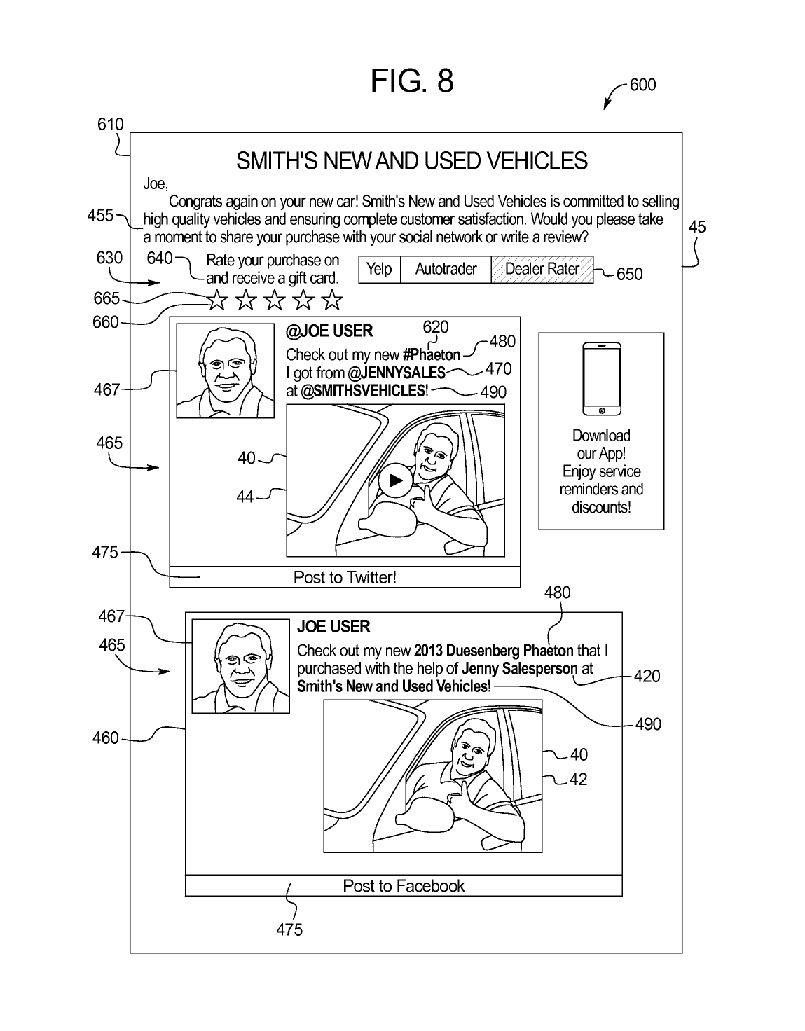

The email message 450 may 450 may include congratulatory text 455 to congratulate the customer 30 on the purchase 50 and to encourage the customer 30 to share a prepopulated status message 460 included in the email message 450. The email message 450 may further include one or more a share prompts 475 to share prepopulated status messages 460 on one or more social networks 70, and may include review prompts 630 to encourage the customer to write reviews 85 for the purchase 50. As will be further described below, in other embodiments, the email message 450 may be an abbreviated version of a longer message 610 (FIG. 8), and/or may include a link 520 (FIG. 7) to the longer message 610. After generating the message 45, the mobile device 10 may then transmit the message 45 to the customer using the customer information 355 provided using the medium 440 chosen.

The prepopulated status message 460 may include the media 40 showing the customer 30 with the purchase 50. The status text 470 of the prepopulated status message 450 may include a product reference 480, referencing the purchase 50, the salesperson social network alias 420, and the business social network alias 430. As shown in FIG. 6, the product reference 480 is a social media alias of a profile page for the purchase 50.

The prepopulated status message 460 may include design elements 465, such as images, layout, colors, fonts, etc., that evoke the actual appearance of a status message 460 once posted on the social network 70. For example, the prepopulated status message 460 may include a profile image 467 of the customer 30 that may be populated using the public profile of the customer 30 on the social network. The prepopulated status message 450 may be generated using an API 75 of the social network 70 to access the design elements 465, the profile image 467, etc. The prepopulated status message 450 may include a share prompt 475 that when visited posts the prepopulated status message 460 on the social network 70.

As shown in FIG. 7 in a SMS messaging screen 500, the message 45 may be a text message 510. The text message 510 may include the media 40 of the customer 30 with the purchase 50. The text message 510 may be an abbreviated version of a longer message 610, and/or may include a link 520 to a longer message 610. The email message may 450 may include congratulatory text 455 to congratulate the customer 30 on the purchase 50 and to encourage the customer 30 to share a prepopulated status message 460 included in the longer message 510.

As mentioned previously, and as shown in FIG. 8, the message 45 may include a link to a longer message 510. The longer message 510 may be a website, and may be served by a purchase sharing server 90. The longer message 510 may include one or more prepopulated status messages 460 with a share prompt 475 to share the purchase 50 on a social network 75. The prepopulated status messages 460 may be prepopulated with the media 40, the salesperson social network alias 420, the business social network alias 430, and a product reference 480. When populated in a prepopulated status messages 460, the salesperson social network alias 420, and the business social network alias 430 may be hyperlinked to social network profiles of the salesperson 20 and the business 25. As shown in FIG. 8, the product reference 480 may be a hashtag 620 referencing a social media stream of posts referencing the purchase 50.

The message 45 may further include review prompts 630 to encourage the customer to write reviews 85 for the purchase 50, the business 25 where the purchase 50 was made, and/or the salesperson 20 on review websites 80. The review prompts 630 may include a review site selector 650 and a review link 660 that when visited pre-populates a review 85 with information about the purchase 50, the business 25, or the salesperson 20. In the example shown in FIG. 8, the review link 660 permits the user to select a rating value 665 between one to five stars. Upon clicking on a star of the review link 660, a review 85 is populated with the appropriate rating value 665. The review prompts 630 may further include incentives 640 to encourage the customer to write a review 85. For example, promising a gift card for writing a review may incentivize a customer 30 to write a review of the purchase.

The share prompts 475 and review prompts 630 may both be hyperlinks configured to provide the functionality described. In an embodiment, a share prompt 475 or a review prompt 630 may be a hyperlink to the desired social network 70 or review website 80 including information of the prepopulated status message 460 or review information contained with the hyperlink. In an alternate embodiment, a share prompts 475 and review prompts 630 may be a hyperlink to a web site associated with the purchase sharing server 90 that uses a social network website application programming interface (“API”) or review website API to create and post the prepopulated status message 460 or pre-populated review.

After a customer 30 activates the share prompt 475 or review prompt 630, the status message 460 may appear in the social network feed of the customer 30, the salesperson 20, and the business 25. In some embodiments, if the purchase 50 has a social media product page, the purchase 50 may also be tagged. In the status message 460, the customer 20, the purchase 50, the salesperson 20, and the business 25 may all be tagged with bolded hyperlinks. The status message 460 may appear to any user of the social network 70 who receives social network updates of any of the tagged entities, and the user may click on any of the tags to view further information. For example, a user may click on the salesperson social network alias 420 to view the salesperson's profile and to contact the salesperson 20 about making a purchase 50.

Purchase sharing may provide opportunities for a salesperson 20 to keep in touch with a customer 30 and monitor customer opinions. For example, purchase sharing may be accomplished by the mobile device 10 in cooperation with a purchase sharing server 90 in order to monitor customer social network activity or to provide timely reminders to the customer 30. The purchase sharing server 90 may perform this functionality by executing a customer relationship management method 250.

In an embodiment shown in FIG. 3b, a customer relationship management method 250 may include steps that when carried out by the processor 104 cause it to: at step 251, receive from a salesperson 20, via a communications network 95, one or more social network aliases 380 and review website aliases 390 of a customer 30, and a product reference 480 to a purchase 50 associated with the social network aliases 380 and review website aliases 390 of a customer 30; at step 252, monitoring, via the communications module 95, the activity of the customer 30 on the social network for activity related to the purchase 50 associated with the social network alias 380 or review website alias 390 of a customer 30; and, at step 253, when activity is detected, transmitting, via the communications module 95, a notification 15 of the activity to the salesperson 20.

At step 251, the purchase sharing server 90 receives one or more social networking aliases 380 and review website aliases 390 of the customer 30 along with the product reference 480. The one or more social networking aliases 380 and review website aliases 390, and product reference 480 may be received from the mobile device 10 after it receives that information at step 202 of the purchase sharing method 200. In an embodiment, the product reference 480 may include the make, model, and date of purchase of a vehicle.

At step 252, the purchase sharing server 90 monitors the activity of the customer 30 on one or more social networks 70 or review websites 80 using the one or more social networking aliases 380 and review website aliases 390. Monitoring may be performed by periodically querying the social networks 70 and the review websites 80 using the appropriate social networking aliases 380 or review website aliases 390. The results of the query may then be searched for a reference to the purchase 50, such as a mention of the purchased item, a hashtag referencing the item, etc. If activity is detected, a notification 15 is generated to reference the activity and is transmitted to the salesperson 20 at step 253. In some embodiments, the activity is a review of the purchase, the salesperson, or the business.

The customer relationship management method 250 may further include steps to remind the customer 30 to take actions associated with the purchase 50, such as maintenance actions. For example, in some embodiments, as shown in FIG. 3b, a customer relationship management method 250 may further include steps that when carried out by the processor 104 cause it to: at step 254, detect the passage of a pre-determined period of time associated with the purchase 50; at step 255, receiving an indication of the downloading of an application to a mobile device, wherein the indication includes one of the one or more social network aliases and review website aliases of a customer; and, at step 256, transmit to the customer 30 a reminder 62 to perform an action associated with the purchase 50.

In some embodiments, the step 255 of transmitting to the customer 30 a reminder 62 to perform an action associated with the purchase 50 is accomplished by transmitting the reminder 62 to a customer mobile device 60. In some embodiments, the pre-determined period of time associated with the purchase 50 may be a length of time since the purchase 50 was made indicating the need for maintenance of the purchase 50. For example, if the purchase 50 is an automobile, the customer 30 may receive a reminder 62 to rotate the tires after six months.

Additionally, the purchase sharing application 65 may be configured to communicate with service scheduling application 65 provided by the business. A service scheduling application 65 may be provided by the business 25 to assist the customer 30 with maintenance of the purchase 50. For example, if the purchase 50 is a vehicle, the service scheduling application 65 may notify the customer 30 of a need to rotate the tires. As another example, the purchase sharing server 90 may communicate with the service scheduling application 65 to permit a salesperson 20 at a business 25 to automatically respond to a download of the service scheduling application 65, perhaps to congratulate the customer 30 on the purchase 50 and to offer future deals on service at the business 25.

Referring back to FIG. 2, the mobile device 10 includes a memory interface 102, one or more data processors, image processors and/or central processors 104, and a peripherals interface 106. The memory interface 102, the one or more processors 104 and/or the peripherals interface 106 can be separate components or can be integrated in one or more integrated circuits. The various components in the mobile device 10 can be coupled by one or more communication buses or signal lines, as will be recognized by those skilled in the art.

Sensors, devices, and additional subsystems can be coupled to the peripherals interface 106 to facilitate various functionalities. For example, a motion sensor 108 (e.g., a gyroscope), a light sensor 110, and a positioning sensor 112 (e.g., GPS receiver) can be coupled to the peripherals interface 106 to facilitate the orientation, lighting, and positioning functions described further herein. Other sensors 114 can also be connected to the peripherals interface 106, such as a proximity sensor, a temperature sensor, a biometric sensor, or other sensing device, to facilitate related functionalities.

A camera subsystem 116 and an optical sensor 118 (e.g., a charged coupled device (CCD) or a complementary metal-oxide semiconductor (CMOS) optical sensor) can be utilized to facilitate camera functions, such as recording photographs and video clips.

Communication functions can be facilitated through one or more wireless communication subsystems 120, which can include radio frequency receivers and transmitters and/or optical (e.g., infrared) receivers and transmitters. The specific design and implementation of the communication subsystem 120 can depend on the communication network(s) over which the mobile device 10 is intended to operate. For example, the mobile device 10 can include communication subsystems 120 designed to operate over a GSM network, a GPRS network, an EDGE network, a Wi-Fi or WiMax network, and a Bluetooth network. In particular, the wireless communication subsystems 120 may include hosting protocols such that the mobile device 10 may be configured as a base station for other wireless devices.

An audio subsystem 122 can be coupled to a speaker 124 and a microphone 126 to facilitate voice-enabled functions, such as voice recognition, voice replication, digital recording, and telephony functions.

The I/O subsystem 128 can include a touch screen controller 130 and/or other input controller(s) 132. The touch-screen controller 130 can be coupled to a touch screen 134. The touch screen 134 and touch screen controller 130 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 134. The other input controller(s) 132 can be coupled to other input/control devices 136, such as one or more buttons, rocker switches, thumb-wheel, infrared port, USB port, and/or a pointer device such as a stylus. The one or more buttons (not shown) can include an up/down button for volume control of the speaker 124 and/or the microphone 126.

The memory interface 102 can be coupled to memory 138. The memory 138 can include high-speed random access memory and/or non-volatile memory, such as one or more magnetic disk storage devices, one or more optical storage devices, and/or flash memory (e.g., NAND, NOR). The memory 138 can store operating system instructions 140, such as Darwin, RTXC, LINUX, UNIX, OS X, iOS, ANDROID, BLACKBERRY OS, BLACKBERRY 10, WINDOWS, or an embedded operating system such as VxWorks. The operating system instructions 140 may include instructions for handling basic system services and for performing hardware dependent tasks. In some implementations, the operating system instructions 140 can be a kernel (e.g., UNIX kernel).

The memory 138 may also store communication instructions 142 to facilitate communicating with one or more additional devices, one or more computers and/or one or more servers 75. The memory 138 may include graphical user interface instructions 144 to facilitate graphic user interface processing; sensor processing instructions 146 to facilitate sensor-related processing and functions; phone instructions 148 to facilitate phone-related processes and functions; electronic messaging instructions 150 to facilitate electronic-messaging related processes and functions; web browsing instructions 152 to facilitate web browsing-related processes and functions; media processing instructions 154 to facilitate media processing-related processes and functions; GPS/Navigation instructions 156 to facilitate GPS and navigation-related processes and instructions; camera instructions 158 to facilitate camera-related processes and functions; and/or other software instructions 160 to facilitate other processes and functions (e.g., access control management functions, etc.). The memory 138 may also store other software instructions controlling other processes and functions of the mobile device 10 as will be recognized by those skilled in the art. In some implementations, the media processing instructions 154 are divided into audio processing instructions and video processing instructions to facilitate audio processing-related processes and functions and video processing-related processes and functions, respectively. An activation record and International Mobile Equipment Identity (IMEI) 162 or similar hardware identifier can also be stored in memory 138.

Each of the above identified instructions and applications can correspond to a set of instructions for performing one or more functions described herein. These instructions need not be implemented as separate software programs, procedures, or modules. The memory 138 can include additional instructions or fewer instructions. Furthermore, various functions of the mobile device 10 may be implemented in hardware and/or in software, including in one or more signal processing and/or application specific integrated circuits. Accordingly, the mobile device 10, as shown in FIG. 2, may be adapted to perform any combination of the functionality described herein.

Aspects of the systems and methods described herein are controlled by one or more processors 104. The one or more processors 104 may be adapted run a variety of application programs, access and store data, including accessing and storing data in associated databases, and enable one or more interactions via the device 10. Typically, the one or more processors 104 are implemented by one or more programmable data processing devices. The hardware elements, operating systems, and programming languages of such devices are conventional in nature, and it is presumed that those skilled in the art are adequately familiar therewith.

For example, the one or more processors 104 may be a PC based implementation of a central control processing system utilizing a central processing unit (CPU), memories and an interconnect bus. The CPU may contain a single microprocessor, or it may contain a plurality of microprocessors 104 for configuring the CPU as a multi-processor system. The memories include a main memory, such as a dynamic random access memory (DRAM) and cache, as well as a read only memory, such as a PROM, EPROM, FLASH-EPROM, or the like. The system may also include any form of volatile or non-volatile memory. In operation, the main memory stores at least portions of instructions for execution by the CPU and data for processing in accord with the executed instructions.

The one or more processors 104 may also include one or more input/output interfaces for communications with one or more processing systems. Although not shown, one or more such interfaces may enable communications via a network, e.g., to enable sending and receiving instructions electronically. The communication links may be wired or wireless.

The one or more processors 104 may further include appropriate input/output ports for interconnection with one or more output displays (e.g., monitors, printers, touchscreen 134, motion-sensing input device 108, etc.) and one or more input mechanisms (e.g., keyboard, mouse, voice, touch, bioelectric devices, magnetic reader, RFID reader, barcode reader, touchscreen 134, motion-sensing input device 108, etc.) serving as one or more user interfaces for the processor. For example, the one or more processors 104 may include a graphics subsystem to drive the output display. The links of the peripherals to the system may be wired connections or use wireless communications.

Although summarized above as a PC-type implementation, those skilled in the art will recognize that the one or more processors 104 also encompasses systems such as host computers, servers, workstations, network terminals, and the like. Further one or more processors 104 may be embodied in a device 10, such as a mobile electronic device, like a smartphone or tablet computer. In fact, the use of the term processor is intended to represent a broad category of components that are well known in the art.

Hence aspects of the systems and methods provided herein encompass hardware and software for controlling the relevant functions. Software may take the form of code or executable instructions for causing a processor or other programmable equipment to perform the relevant steps, where the code or instructions are carried by or otherwise embodied in a medium readable by the processor or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A purchase sharing system, comprising:
a processor;
a camera controlled by the processor;
a user interface controlled by the processor;
a wireless communications module controlled by the processor; and
tangible non-transitory computer-readable media having instructions, that when executed by the processor, cause the processor to perform the steps of:
receive, from the camera, an input of media;
receive, from the user interface, customer information;
generating a message to the customer, wherein the message includes media, and a prepopulated status message, wherein the prepopulated status message include a reference to a product, a reference to a salesperson, and a reference to a business at which the product was purchased, and a link to a URL that when visited posts the prepopulated status message on the social network;
transmitting, via the wireless communications module, the message to the customer.

2. The system of claim 1, wherein the message is one of an email or an SMS message.

3. The system of claim 1, wherein the media is one of an image or a video.

4. The system of claim 1, wherein the reference to the product is a link to a social network profile of the product, wherein the reference to the salesperson is a link to a social network profile of the salesperson, and wherein the reference to the business is a link to a social network profile of the business.

5. The system of claim 1, wherein the reference to the product is a link to a website of the product, wherein the reference to the salesperson is a link to a website of the salesperson, and wherein the reference to the business is a link to a website of the business.

6. The system of claim 1, wherein the message is an SMS message, wherein the message includes an abbreviated portion sent via SMS and a full version accessible using a uniform resource locator, and wherein the abbreviated portion includes the uniform resource locator.

7. A purchase sharing system, comprising:
a processor;
a communications module controlled by the processor; and
tangible non-transitory computer-readable media having instructions, that when executed by the processor, cause the processor to perform the steps of:
receive, via the communications module, one or more social network aliases and review website aliases of a customer, and a product reference to a purchase associated with the social network aliases and review website aliases of the customer;
monitoring, via the communications module, the activity of the customer on a social network for activity related to the purchase associated with the social network alias or review website alias of a customer; and
when activity is detected, transmitting, via the communications module, a notification of the activity.

8. The system of claim 7, wherein the activity is a review of one of the purchase, a salesperson, and a business.

9. The system of claim 7, wherein the tangible non-transitory computer-readable media has further instructions, that when executed by the processor, cause the processor to perform the steps of:
detecting the passage of a pre-determined period of time associated with the purchase; and
transmitting to the customer a reminder to perform an action associated with the purchase.

10. The system of claim 9, wherein the reminder is a reminder to service the vehicle.

11. The system of claim 7, wherein the product reference is the make, model, and date of purchase of a vehicle.

12. The system of claim 7, wherein the tangible non-transitory computer-readable media has further instructions, that when executed by the processor, cause the processor to perform the steps of:
receiving an indication of the downloading of an application to a mobile device, wherein the indication includes one of the one or more social network aliases and review website aliases of a customer; and
wherein the step of transmitting to the customer a reminder to perform an action associated with the purchase is accomplished by transmitting the reminder to the mobile device.
